(19) United States
(12) Patent Application Publication
(10) Pub. No.: US 2010/0301737 A1
(43) Pub. Date: Dec. 2, 2010

(54) LOW WORK FUNCTION ELECTRODE

(76) Inventor: Alex Mann, Vaughan (CA)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 12/787,874

(22) Filed: May 26, 2010

Related U.S. Application Data
(60) Provisional application No. 61/181,069, filed on May 26, 2009.

(51) Int. Cl. H01J 1/02

(52) U.S. Cl. 313/352

(57) ABSTRACT

A low work function electrode is provided for use in thin film electronic devices. The low work function electrode for use in thin file electronic devices. The low work function electrode comprises a LCE comprising a conductive ceramic material comprising a low work function conductive ceramic material (LCM) and at least one higher work conductive material (HCM) having a higher work function than the LCM. The combination of the LCM and the HCM provides an effective work function of the LCE.

### CROSS-REFERENCE TO RELATED APPLICATIONS

This application claims priority from U.S. Provisional Patent Application No. 61/181,069 filed May 26, 2009, hereby incorporated by reference.

### TECHNICAL FIELD

The present disclosure relates generally to electrodes and in particular it relates to creating a stable low work function electrode for use in thin film electronic devices.

### BACKGROUND

Currently more than 90% of photovoltaic devices (solar cells) are made from silicon and consist of 3 main types: single crystalline silicon, polycrystalline silicon or amorphous silicon. Single crystalline silicon solar cells are efficient but not cost effective per kWh. In an effort to increase the cost effectiveness of silicon solar cells polycrystalline silicon cells were developed. While polycrystalline silicon is not as ordered as single crystalline silicon, which results in lower conversion efficiencies, it is cheaper to produce. To further reduce costs, amorphous silicon may be used for solar cells; however this further reduces the order and thus the efficiency. Unfortunately none of the silicon solar cells are truly cost effective (per kWh); thus the use of thin films is of particular interest.

Thin-film solar cells use less than 1% of the raw materials compared to the wafer based technologies. In addition to silicon (Si), thin film structures may be also made from other materials, including Copper Indium Gallium DiSelenide (CIGS), Copper Indium DiSelenide (CIS), Cadmium Telluride (CdTe), Dye Sensitized (DSC) and Organic Conductive Polymers each of which has its own unique issues. In the past twenty years, research activity has increased dramatically in the field of conductive polymers after the discovery that conjugated polymers can behave as metallic conductors and semiconductors. Unfortunately, the efficiencies achieved with the first and second generations of conductive polymer solar cells were disappointing. The third generation of conductive polymer cells consisted of a bulk heterojunction combined with exotic elements such as fullerenes, carbon nanotubes, and titanite rods. While large improvements over its predecessors were observed, the efficiencies required to create a commercially viable solar cell have still not been achieved due to deficiencies in charge collection.

A stable low work function electrode is an element which can significantly enhance the performance of an organic polymer solar cell, but there are manufacturing and longevity problems which make this a difficult challenge. Accordingly, a viable low work function electrode for use in thin film applications remains highly desirable.

### SUMMARY

In accordance with an aspect of the present disclosure there is provided a low work function electrode for use in thin film electronic devices, the low work function electrode comprising a low work function composite conductive ceramic element (LCE) comprising a low work function conductive ceramic material (LCM), and at least one higher work conductive material (HCM) having a higher work function than the LCM wherein the combination of the LCM and the HCM provide an effective work function of the LCE.

In accordance with another aspect of the present disclosure there is provided a low work function electrode for use in thin film electronic devices, the low work function electrode comprising: a low work function composite conductive ceramic element (LCE) comprising a low work function conductive ceramic material (LCM) and at least one higher work conductive material (HCM) having a higher work function than the LCM, wherein the combination of the LCM and the HCM provide an effective work function of the LCE; and a charge collection element (CCE) deposited in contact with the LCE as a parallel plane layer.

Other aspects and advantages of the present disclosure will become obvious to the reader and it is intended that these aspects and advantages are within the scope of the present disclosure. To the accomplishment of the above and related aspects, this disclosure may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Further features and advantages of the present disclosure will become apparent from the following detailed description, taken in combination with the appended drawings, in which:

FIG. 1 shows a diagram of the mechanism of contact potential difference between materials with different work functions;

FIG. 2 shows a side view of a low work function electrode;

FIG. 3 shows a side view of an alternate low work function electrode;

FIG. 4a is a side view and FIGS. 4b and 4c are bottom views of an alternate low work function electrode;

FIG. 5 is a side view of an alternate low work function electrode where an insulator element is deposited;

FIG. 6 is a side view of an alternate low work function electrode where a collection element and an insulator element is deposited;

FIG. 7A-D show side views of several alternate low work function electrodes where there is a collection element embedded within the low work function composite conductive ceramic element.

Various other aspects, features and attendant advantages of the present disclosure will become fully appreciated as the same becomes better understood when considered in conjunction with the accompanying drawings, in which like reference characters designate the same or similar parts throughout the several views, and wherein: It will be noted that throughout the appended drawings, like features are identified by like reference numerals.

### DETAILED DESCRIPTION

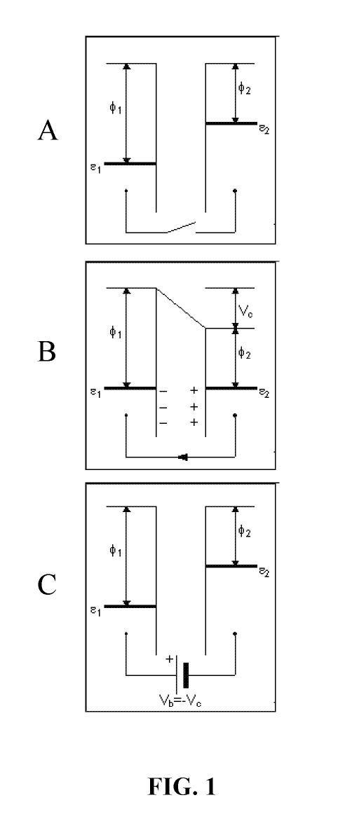

Embodiments are described below, by way of example only, with reference to FIGS. 1-7.

The present disclosure consists of a “tuneable low work function” electrode capable of being fabricated with a very low work function, that is chemically stable through its entire range of tuning, capable of being transparent or reflective as needed, which provides a strong current-carrying element that transports charges between the active semi-conductive layer of a thin film electronic device to points where they can perform a useful function. The low work function electrode can be fabricated by a variety of methods, with minor variants in its structure in order to optimize it for its fabrication method.

Photovoltaic structures are part of a specialized group of semiconductor structures that convert photons into electricity. Fundamentally, the device needs to fulfill four functions: (i) the photo-generation of exciton-state bound charges in a light-absorbing material, (ii) the transport of excitons to locations where they can be split (typically by a P-N junction interface), (iii) the splitting of the excitons into free charge carriers (electrons and holes), (iv) and separation of the charge carriers to a conductive contact that will transmit the electricity.

Silicon photovoltaic cells commonly are configured as a large-area p-n junction (“p” denoting positive, “n” denoting negative). When p-type silicon is brought into contact with a piece of n-type silicon, a diffusion of electrons occurs from the region of high electron concentration (the n-type side of the junction) into the region of low electron concentration (p-type side of the junction). When the electrons diffuse across the p-n junction, they recombine with holes on the p-type side.

This diffusion of electrons and holes creates an electric field by the imbalance of charge immediately on either side of the junction. The electric field established across the p-n junction creates a diode that promotes current to flow in only one direction across the junction. Electrons may pass from the n-type side into the p-type side, and holes may pass from the p-type side to the n-type side. This region where electrons have diffused across the junction is called the depletion region because it no longer contains any mobile charge carriers. It is also known as the space charge region or depletion layer.

To connect the photovoltaic cell to a load, ohmic conductor-semiconductor junctions are typically made to both the n-type and p-type sides of the solar cell via electrodes, which are then connected to an external load. Such junctions require a matching of the work function of the conductor to the LUMO (lowest unoccupied molecular orbital) or HOMO (highest occupied molecular orbital) energies of the semiconductor in order to efficiently move charges from one material to the other

Next generation solar cells are required to truly achieve high efficiencies with light weight and low cost. Organic photovoltaic (OPV) cells can provide a platform for achieving cost/performance breakthroughs because of the inherent ease with which many variants of an organic molecule can be synthesized. This synthetic flexibility allows the properties of the solar cells to be tuned to particular applications. The ability to add solubilising groups to organic molecules also allows for the use of new and less costly techniques, such as inkjet printing, in the manufacturing process. Finally, organic molecules tend to have much more inherent physical flexibility, which could expand the range of applications to which solar cells could be used. The combination of lower costs and better adaptability should provide a boost in the desirability of solar power.

OPVs generally consist of a donor material and acceptor material, which are similar in concept to the two types of doped silicon, although unlike silicon solar cells, the donor and acceptor in an OPV are generally completely different materials. OPV cells can be constructed in a variety of ways, including single layer, bilayer heterojunction, and bulk heterojunction cells. Single layer cells and bi-layer heterojunction cells have been mostly abandoned in favour of bulk heterojunction cells.

The purpose of a bulk heterojunction configuration is to reduce the distance an exciton must travel before reaching a donor-acceptor interface which is able to split it into a free electron charge and free hole charge. Because bulk heterojunctions feature completely interpenetrating donor and acceptor materials, they provide a shorter distance for exciton travel to a splitting point, which helps reduce the chance of exciton recombination.

At the time that they are created by exciton splitting at the randomly-dispersed p-n junctions within bulk heterojunctions, free charges are generally in a random distribution throughout the photoactive layer, and thus the net built-in potential within the photovoltaic material is zero. Therefore, the only force driving free charges toward the electrodes is provided by the electric field formed between the low work function cathode and a high work function anode. The intensity of this electric field is proportional to the gradient of potential between the cathode and the anode, which, in turn is proportional to the difference in their work functions.

Within organic thin film electronic devices, the inclusion of a high work function electrodes and low work function electrodes is important because, contrary to classic silicon bi-layer p-n junction constructs where an intrinsic electric field exists across the junction and drives the hole and electron free charge carriers in separate directions, within a bulk heterojunction organic polymer photovoltaic cell, the donors and acceptors are intimately mixed rather than being placed in well-defined layers.

It is also important as the ability to match the Fermi energy level of the electrode and the highest (HOMO) and/or lowest (LUMO) molecular orbitals of the adjacent layers comprising the thin film electronic device should lower the magnitude of the barrier for charge collection or for charge injection—effectively increasing the efficiency of the device. Being able to tune the work function of the electrode would make optimization a much simpler task. In addition, a tuneable work function electrode material would enable the use of the electrode in conjunction with a wide range of semi-conductor materials.

In addition to the above attributes, when the low work function electrode is used in an organic photovoltaic device, maximum absorption of the solar spectrum is desirable. The most strongly absorbing transitions are quite often less than 100 nm thick, and this is not enough to give full coverage. One additional solution to this problem is to stack multiple photoactive layers within a single cell, each providing additional bands of absorption. In organic polymer cells, this is called tandem configuration.

In organic polymer cells, the tandem cell increase in efficiency does not greatly increase the complexity of the cell, but it does require a band-transparent low work function electrode in order for light to reach a second photovoltaic layer. If the electrode reflects less-penetrating IR light back upward from underneath the IR-band absorbing upper optical layer of a tandem cell and yet passes other light bands through to a subsequent photovoltaic layer, this is an example of an enhanced tandem device.

More research must be done in this overall area to determine greater improvements that can be effected by molecular or structural modification, however, a low work function electrode that is stable and easily tuneable would greatly enhance the efficiency of simple organic polymer photovoltaic cells.

Conductive Ceramics for Use in a Low Work Function Electrode

Most low work function materials are inherently reactive. Ideally, an optimal candidate for a low work function electrode material would have relatively good conductivity, be easy to work with, have relatively low density, be chemically stable, and, of course, would have a low work function. Ceramics are inorganic non-metallic materials that are formed by the action of heat. Possible conductive ceramics that may be utilized are TiN; ZrN; ZrB₂; HfB₂; NbB; Nb₃B₂; CrB; CrB₂; CrB₄; Cr₅B₃; LaB₆ ;CeB₆; GdB₄; SrB₆; ThB₆; and CaB₆ however some conductive ceramics may be more suitable than depending on the application. Conductive ceramic materials represent a group of metal substitutes with, in some cases, relatively good electrical conductivity and low chemical reactiveness, and therefore high stability.

The Benefits of a Stable Low Work Function Electrode

The advantages of a low work function electrode can be easily demonstrated in the example of thin film photovoltaic (PV) cell. In the case of a photovoltaic cell the process of charge exchange between anode and cathode (the plates of capacitor), which induces the internal electric field and creates the cell voltage, can be shown in the form of diagrams:

FIG. 1 shows various electron energy diagrams for anode and cathode (two conducting electrodes) of PV cell.

As shown in FIG. 1-A The electron energy levels diagram for anode and cathode, where φ1 and φ2 are the work functions of the anode and cathode respectively, and ε1 and ε2 represent their Fermi levels. When PV cell is radiated by solar light, an electrical contact is made between the two electrodes, their Fermi levels equalize and the resulting flow of charge (in direction indicated) produces a potential gradient between the plates, termed the contact potential (Vc). The two surfaces become equally and oppositely charged.

The potential gradient induces an internal electrical field between the electrodes. The internal electrical field drives the photo-generated free charges towards the electrodes.

From FIG. 1-B it can be easily seen that a higher difference between work functions of the anode and cathode produces a stronger internal electrical field in the PV cell, potentially resulting in more intense charge transfer and stronger photocurrent.

Inclusion of a variable “backing potential” (Vb) in the external circuit as shown in FIG. 1-C permits biasing of one electrode with respect to the other. At the unique point where the (average) electric field between the plates vanishes, one can determine an open circuit voltage.

From this diagram it can be seen that a higher difference between the work functions of anode and cathode elements produces higher open circuit voltage of the PV cell. Thus a low work function electrode is potentially a beneficial part of a photovoltaic device

A Low Work Function Electrode in a Bulk Heterojunction Device

Contrary to classic bi-layer p-n heterojunctions, where an intrinsic electric field exists across the junction and drives the free charge carriers, the absence of an intrinsic electric field within a bulk heterojunction results in a situation where the only force driving free charges toward the electrodes is provided by the electric field formed between a low work function cathode and a high work function anode. The intensity of this electric field is proportional to the gradient of electric potential between the cathode and the anode, which, in turn is proportional to the difference in their work functions.

### Example

For a PV cell layered in the sequence PEDOT-[PCBM+P3HT]-Al, when PEDOT serves as anode and aluminum serves as cathode, the work function difference is equal to:

Δφ=φ(PEDOT)−φ(Al)=5.0 eV=4.25 eV=0.75 eV

If the low work function cathode made of, for example, niobium carbide with a work function of 3.5 eV is used instead of aluminum, the difference in work function between the electrodes is doubled, with a respective increase in the intensity of a driving electric field between electrodes:

Δφ=(PEDOT)−φ(NbC)=5.0 eV−3.5 eV=1.5 eV

The conversion efficiency of a solar cell depends directly on the intensity of charge transfer. The charge transfer intensity is proportional to the mobility of free charges within the photo-conversion layer of PV cell. In its turn, the mobility of a free charge is proportional to a free charge's drift velocity, which is proportional to the strength of the applied electric field.

So the increased intensity of a driving electric field between electrodes will result in more than a doubling of the drift velocity.

As a result, the increased intensity of a driving electric field will:

Increase the chance of excitons reaching a distant p-n junction before they recombine.

Provide more free charges that reach the electrodes per unit of time, increasing the photocurrent—in this case by at least 50%.

More efficient exciton splitting and higher photocurrent assist in minimizing losses related to inefficient charge transfer. In other aspects of this disclosure, these benefits allow doubling the thickness of the active PV layer, doubling the degree of light absorption.

The primary functions of an low work function electrode within a thin film electronic device are:

Together with a high work function electrode, to provide a strong electric field across a thin film electronic device, assisting the process of charge transfer through the device.

To efficiently collect and conduct free charges between a semi-conductive functional layer (such as a photovoltaic layer) and a charge collection element which extracts electrons from a thin film electronic device.

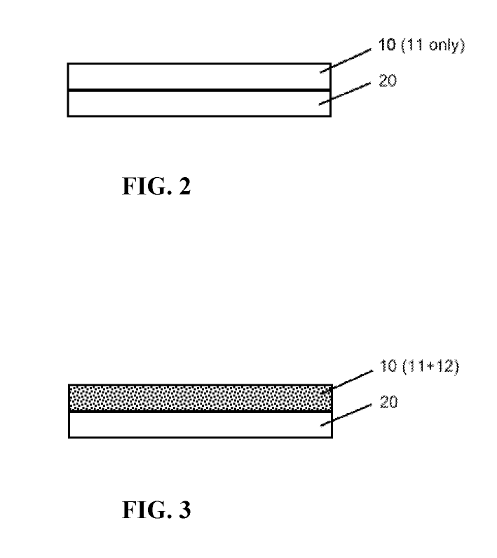

Referring now to FIG. 2, one element of a low work function electrode is a composite low work function conductive ceramic element (LCE 10). LCE 10 includes a composite ceramic conductor (LCC 11), and potentially other components described herein.

LCC 11 is comprised of both a stable low work function conductive ceramic material (LCM) and at least one highly conductive higher work function material (HCM), wherein the work function of HCM is greater than the work function of LCM.

LCE 10 may additionally contain other components beside LCC 11 in order to assist in manufacturing. Examples of these are binder materials 12 and solvents (not depicted). Again, LCE 10 always contains LCC 11 and may for example contain binder materials 12.

One embodiment the LCM is one comprised of boron-bound lanthanides such as lanthanum hexaboride or cerium hexaboride. Those skilled in the art of materials science can understand that these unusual materials can exhibit low work function and yet paradoxically cannot easily react with other materials. In an embodiment of LCC 11, the LCM is lanthanum hexaboride particles, while the HCM is comprised of silver nanoparticles, both in the range of 50 nm in diameter.

By varying the ratio of the LCM and HCM materials within in a thin film

LCC, the effective work function of the LCC can be adjusted or tuned to a value between the work function of the LCM and the work function of the HCM. Thus (by derivation) the low work function electrode can be adjusted to have a efficient work function match to an adjacent semiconductor layer in a thin film device.

The choice of a specific LCC composition should be based on a combination of proper conductivity which is needed to support the functioning of the specific thin film electronic device, and the work function needed to assure proper energy level matching. For example, in a one embodiment, combining a LCM of lanthanum hexaboride (work function φ=2.7 eV) with a HCM of PEDOT:PSS (work function φ=5.0 eV) at different ratios, it is possible to tune the work function of LCC in the range of 2.7-5.0 eV, which becomes an extremely valuable instrument in the designing of specific thin film electronic devices.

LCE 10 can be fabricated in several basic forms:

With deposition techniques can include PVD (physical vapour deposition), CVD (chemical vapour deposition), PAPVD (plasma assisted physical vapour deposition), a simple LCE 10 comprised only of LCC 11 can be deposited.

With a “nano—layered” LCC 11 that can be fabricated. comprised of very thin interleaved layers of LCM and HCM, using the same set of deposition techniques. The thickness and the number of the layers chosen alters volume ratio of the LCM and the HCM, which in turn affects the work function of LCC 10.

As illustrated in FIG. 3, a more rapidly-manufactured LCE 10 can be fabricated with a mixture of LCC 11 and an additional binder 12 and optionally a solvent such as an alcohol or water which is removed after deposition. Binder 12 may be conductive, semi-conductive or insulative. It serves as a matrix in LCE 10, allowing high speed deposition by various coating techniques including screen printing, inkjet printing and roll coat printing.

Depending on the specific construct and the function of the thin film electronic device, LCE 10 can typically be deposited as an overall layer with a thickness from 10 nm up to 3 mm.

The concept that material shapes and aspect ratios have major effects upon the conductive percolation limits of composite conductive-particle/binder mixtures is a complex but much-studied science, which applies strongly to the selection of materials. For example, by using specific combinations of differently sized particles, it is possible to achieve the densest packing within the layer, which generally yields better overall conductivity. Another example is that use of higher aspect ratio conductive particles is known to generally achieve conductivity percolation at lower concentrations of conductive particles within the binder. Finally, the particle size of a material also affects its work function, and must be carefully considered when designing the LCE 10.

Within an embodiment (although many larger dimensions and aspect rations also work to varying degrees) the size of LCC 11 particles can be from 1 nm up to 40 μm in maximum dimension, with aspect ratios typically ranging up to 100:1. The thickness of a nano-layer of a multi-layered LCC 11 is typically below 150 nm.

Depending on the specific function of thin film electronic device, the LCE 10 can be made transparent or selectively transparent. In such a case, LCC 11 and binder 12 are either inherently transparent, or the size of its particles are chosen so that the particles do not interact with the light in the region of desirable band transparency.

Referring now to FIGS. 2 and 3, a charge collection element (CCE 20) is fabricated as a layer adjacent to LCE 10. The main function of CCE 20 is to efficiently carry electric currents to or from LCE 10. Even though the LCE 10 is capable of conducting electricity, its main function is to conduct the current in a direction transversal to its layer, connecting between the functional layer of the thin film device to the much more conductive CCE 20.

CCE 20 should therefore be highly conductive. As such, the CCE 20 can be chosen among standard conductive materials available in the industry. In an embodiment, CCE 20 is fabricated from copper or silver inks. Depending upon the requirements of the thin film electronic device, it is also possible to select a material for CCE 20 that allows either transparency ranges or reflectivity ranges within the common photovoltaic spectrum.

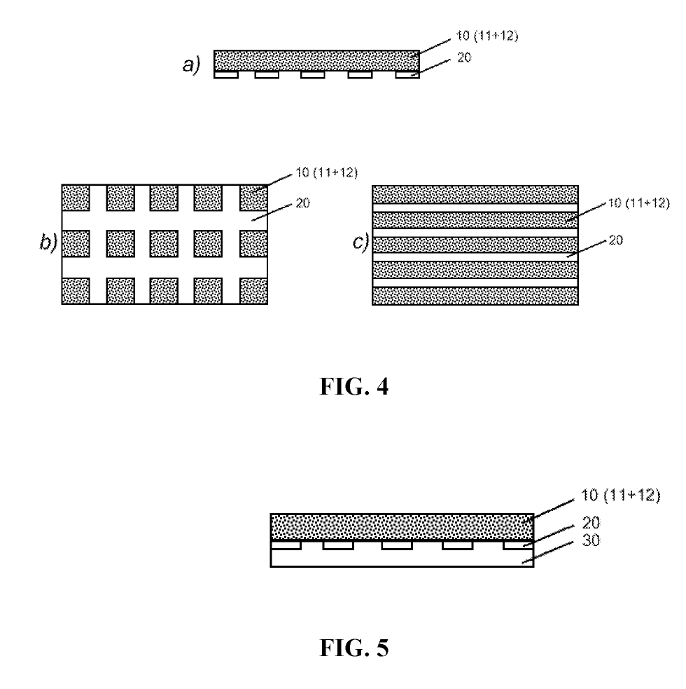

CCE 20 can be fabricated as a continuous layer, or (referring now to FIG. 4), CCE 20 can be grid or an array of lines. Looking from the bottom upward, (b) shows a conductive grid, and (c) shows an array of conductive lines or wires.

Referring now to FIG. 7, in some embodiments of the low work function electrode, CCE 20 can be fabricated inside layers of LCE 10. CCE 20 can be a continuous layer (b) or a conductive grid or an array of conductive lines or wires (a, c, d). One possible application of this type of low work function electrode is a tandem thin film electronic device with a central transparent low work function electrode between two photovoltaic layers. Such an electrode is useful in tandem devices, where un-absorbed light passes through the top photo-active layer and through the transparent low work function electrode into a second photo-active layer, where more of the light is then absorbed. In such an embodiment, LCC 10 and CCE 20 are fabricated to be transparent or selectively transparent, for example by using nano-sized particles and inherently transparent materials.

Referring now to FIG. 5, a side view shows an added feature of the low work function electrode, insulator 30. The main functions of insulator 30 are:

To provide electrical insulation within certain parts of the low work function electrode.

To protect the low work function electrode and the layers adjacent to it, from the adverse effects of UV, humidity and temperature in outdoor environments.

In an embodiment, insulator 30 is chosen among standard materials with high electrical and weathering resistance. More specifically, an embodiment of insulator 30 can be a UV- or IR-curable, printable material that is electrically non-conductive, resistant to UV, heat, moisture, and also scratch resistant.

In an embodiment, insulator 30 is essentially as a layer below LCE 10 and CCE 20, deposited as a continuous covering for the underside of LCE 10 and CCE 20.

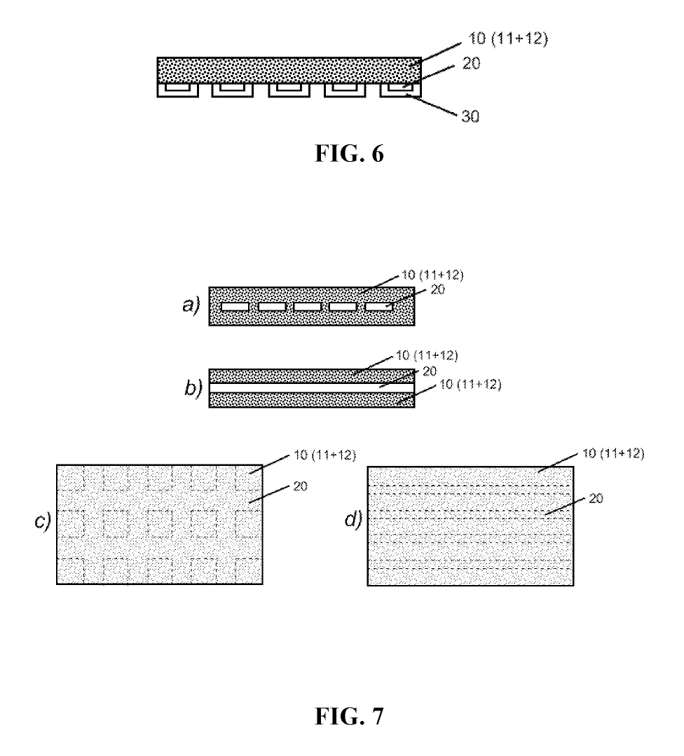

Referring now to FIG. 6, insulator 30 can alternately be fabricated as a non-continuous layer, covering only the exposed underside of a grid or array of lines of CCE 20.

Thus, the tuneable work function electrode is provided, capable of being fabricated with a very low work function, chemically stable through its entire range of tuning, capable of being transparent or reflective as needed, with a strong current-carrying element that transports the charges between the active semi-conductive layer of a thin film electronic device to points where they can perform a useful function. The low work function electrode can be fabricated by a variety of methods, with minor variants in its structure used in order to optimize it for a specific fabrication method.

1. A low work function electrode for use in thin film electronic devices, the low work function electrode comprising a low work function composite conductive ceramic element (LCE) comprising a low work function conductive ceramic material (LCM), and at least one higher work conductive material (HCM) having a higher work function than the LCM wherein the combination of the LCM and the HCM provide an effective work function of the LCE.

2. The low work function electrode of claim 1 wherein the LCM is selected from the group comprising TiN; ZrN; ZrB₂; HfB₂; NbB; Nb₃B₂; CrB; CrB₂; CrB₄; Cr₅B₃; LaB₆; CeB₆; GdB₄; SrB₆; ThB₆; and CaB₆.

3. The low work function electrode of claim 1 wherein the LCM is LaB6.

4. The low work function electrode of claim 1 wherein the size of LCM particles and HCM particles are from 1 nm up to 40 μm in maximum dimension.

5. The low work function electrode of claim 1 wherein the effective work function of the LCE is determined in part by mixing different ratios of the LCM particles and HCM particles together.

6. The low work function electrode of claim 5 wherein the LCE is a mixture of LCM particles and HCM particles with a non-conductive binder material.

7. The low work function electrode of claim 5 wherein the LCE is a mixture of LCM and HCM wherein HCM acts as a conductive binder material.

8. The low work function electrode of claim 1 wherein the effect work function of the LCE is determined in part by interleaving layers of LCM with alternating layers of HCM in different ratios of layer thickness.

9. The low work function electrode of claim 1 wherein the LCE is deposited at a thickness from 20 nm up to 3 mm.

10. The low work function electrode of claim 1 wherein the low work function electrode is substantially transparent in a portion of the visible light spectrum.

11. The low work function electrode of claim 1 wherein the low work function electrode is substantially reflective in a portion of the visible light spectrum.

12. The low work function electrode of claim 1 further comprising a charge collection element (CCE) deposited as a layer in contact with the LCE, the CCE structure selected from the group comprising: a conductive grid, an array of conductive wires, and a continuous conductive layer.

13. A low work function electrode for use in thin film electronic devices, the low work function electrode comprising:
a low work function composite conductive ceramic element (LCE) comprising a low work function conductive ceramic material (LCM) and at least one higher work conductive material (HCM) having a higher work function than the LCM, wherein the combination of the LCM and the HCM provide an effective work function of the LCE; and
a charge collection element (CCE) deposited in contact with the LCE as a parallel plane layer.

14. The low work function electrode of claim 13 wherein the CCE is deposited as a layer in contact with the LCE, and the CCE structure selected from the group comprising: a conductive grid, an array of conductive wires, and a continuous conductive layer.

15. The low work function electrode of claim 14 wherein the low work function electrode is substantially transparent in a portion of the visible light spectrum.

16. The low work function electrode of claim 14 wherein the low work function electrode is substantially reflective in a portion of the visible light spectrum.

17. The low work function electrode of claim 13 wherein the LCM is selected from the group comprising TiN; ZrN; ZrB₂; HfB₂; NbB; Nb₃B₂; CrB; CrB₂; CrB₄; Cr₅B₃; LaB₆; CeB₆; GdB₄; SrB₆; ThB₆; and CaB₆.

18. The low work function electrode of claim 13 wherein the LCM is LaB₆.

19. The low work function electrode of claim 13 wherein the effective work function of the LCE is determined in part by mixing different ratios of the LCM particles and HCM particles together.

20. The low work function electrode of claim 19 wherein the size of LCM particles and HCM particles are from 1 nm up to 40 μm in maximum dimension.

21. The low work function electrode of claim 19 wherein the LCE is a mixture of LCM particles and HCM particles with a non-conductive binder material.

22. The low work function electrode of claim 21 wherein the size of LCM particles and HCM particles are from 1 nm up to 40 μm in maximum dimension.

23. The low work function electrode of claim 19 wherein the LCE is a mixture of LCM and HCM wherein HCM acts as a conductive binder material.

24. The low work function electrode of claim 13 wherein the effect work function of the LCE is determined in part by interleaving layers of LCM with alternating layers of HCM in different ratios of layer thickness.
